(19) United States
(12) Patent Application Publication
(10) Pub. No.: US 2005/0259822 A1
(43) Pub. Date: Nov. 24, 2005

(54) Sinusoidal audio coding

(75) Inventors: Robert Johannes Sluijter, Eindhoven (NL); Andreas Johannes Gerrits, Eindhoven (NL); Gerard Herman Hotho, Eindhoven (NL); Albertus Cornelis Den Brinker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/520,196

(22) PCT Filed: Jun. 18, 2003
(86) PCT No.: PCT/IB03/02746

§ 371 Date: Jan. 4, 2005

(30) Foreign Application Priority Data
Jul. 8, 2002 (EP) 02077727.2

(51) Int. Cl. H04N 7/167

(52) U.S. Cl. 380/236

(57) ABSTRACT

Coding (1) an audio signal (x) comprises providing a respective set of sampled signal values for each of a plurality of sequential segments. The sampled signal values are analysed (130) to generate one or more sinusoidal components for each of the plurality of sequential segments. The sinusoidal components are linked across a plurality of sequential segments. Sinusoidal codes (CS) comprise tracks of linked sinusoidal components for each of the plurality of sequential segments. Each track comprises a frequency and amplitude for a sinusoidal component in a starting segment of a track whereas selected tracks include an indicator that no phase is included for said starting segment.

### FIELD OF THE INVENTION

The present invention relates to coding and decoding audio signals.

### BACKGROUND OF THE INVENTION

A parametric coding scheme in particular a sinusoidal coder is described in WO 00/79519-A1 (Attorney Ref. PHN 017502) and PCT Patent Application No. IB02/01297 (Attorney Ref. PHNL010252). In this coder, an audio segment or frame is modelled by a sinusoidal coder using a number of sinusoids represented by amplitude, frequency and phase parameters. Once the sinusoids for a segment are estimated, a tracking algorithm is initiated. This algorithm tries to link sinusoids with each other on a segment-to-segment basis. Sinusoidal parameters from appropriate sinusoids from consecutive segments are thus linked to obtain so-called tracks. The linking criterion is based on the frequencies of two subsequent segments, but also amplitude and/or phase information can be used. This information is combined in a cost function that determines the sinusoids to be linked. The tracking algorithm thus results in sinusoidal tracks that start at a specific time instance, evolve for a certain amount of time over a plurality of time segments and then stop.

In the scheme, for a sinusoidal track, the initial phase is transmitted and the phases of the other sinusoids in the track are retrieved from this initial phase and the frequencies of the other sinusoids. The amplitude and frequency of a sinusoid can also be encoded differentially with respect to the previous sinusoids. Furthermore, tracks that are very short can be removed. As such, due to the tracking, the bit rate of a sinusoidal coder can be lowered considerably.

### DISCLOSURE OF THE INVENTION

According to the present invention there is provided a method of encoding an audio signal according to claim 1.

### BRIEF DESCRIPTION OF THE DRAWINGS

FIG. 1 shows an embodiment of an audio coder according to the invention;

FIG. 2 shows an embodiment of an audio player according to the invention; and

FIG. 3 shows a system comprising an audio coder and an audio player according to the invention;

### DESCRIPTION OF THE PREFERRED EMBODIMENT

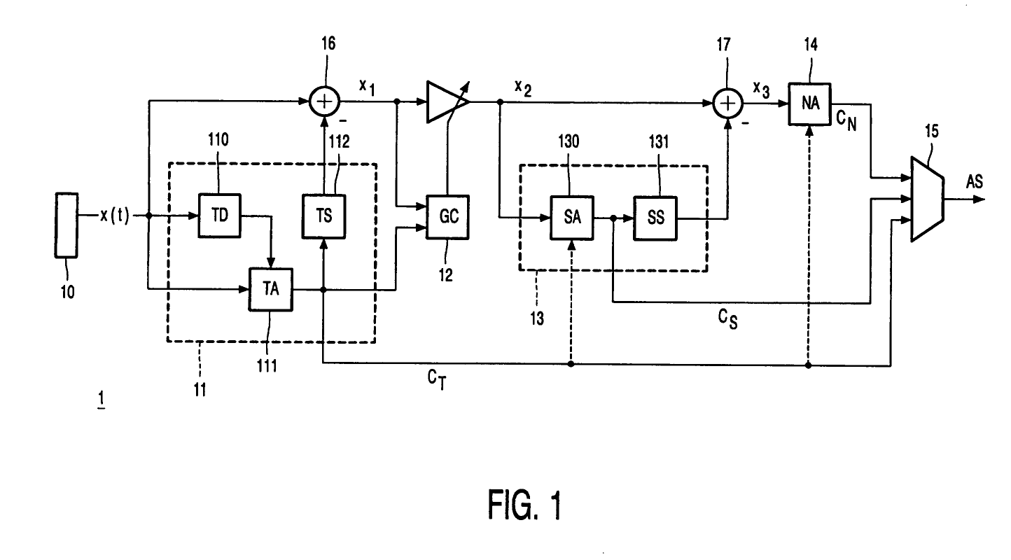

In a preferred embodiment of the present invention, FIG. 1, the encoder is a sinusoidal coder of the type described in WO 01/69593-A1 (Attorney Ref. PHNL000120). The operation of this coder and its corresponding decoder has been well described and description is only provided here where relevant to the present invention.

In both the earlier case and the preferred embodiment, the audio coder 1 samples an input audio signal at a certain sampling frequency resulting in a digital representation x(t) of the audio signal. The coder 1 then separates the sampled input signal into three components: transient signal components, sustained deterministic components, and sustained stochastic components. The audio coder 1 comprises a transient coder 11, a sinusoidal coder 13 and a noise coder 14. The audio coder optionally comprises a gain compression mechanism (GC) 12.

The transient coder 11 comprises a transient detector (TD) 110, a transient analyzer (TA) 111 and a transient synthesizer (TS) 112. First, the signal x(t) enters the transient detector 110. This detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code CT and more detailed information on generating the transient code CT is provided in WO 01/69593-A1.

The transient code CT is furnished to the transient synthesizer 112. The synthesized transient signal component is subtracted from the input signal x(t) in subtractor 16, resulting in a signal x1. In case, the GC 12 is omitted, x1=x2.

The signal x2 is furnished to the sinusoidal coder 13 where it is analyzed in a sinusoidal analyzer (SA) 130, which determines the (deterministic) sinusoidal components. It will therefore be seen that while the presence of the transient analyser is desirable, it is not necessary and the invention can be implemented without such an analyser. In any case, the end result of sinusoidal coding is a sinusoidal code CS and a more detailed example illustrating the conventional generation of an exemplary sinusoidal code CS is provided in WO 00/79519-A1.

In brief, however, such a sinusoidal coder encodes the input signal x2 as tracks of sinusoidal components linked from one frame segment to the next. In the prior art, the tracks are initially represented by a start frequency, a start amplitude and a start phase for a sinusoid beginning in a given segment—a birth.

In the preferred embodiment of the present invention, a start phase is selectively encoded for a track as a function of the length of the track. More particularly, a start-phase is only employed for tracks of long duration. This is because it is assumed that tracks of long duration are probably encoding tonal information and in such cases, it is important to preserve the tonal characteristics of the track as much as possible by transmitting the start phase of the track. Tracks of short duration are assumed to be encoding non-tonal information and thus transmitting a start phase with such tracks may in fact add a tonal characteristic to a track and so render a perception of distortion when re-playing the encoded bitstream.

It will be seen that there may be a significant saving in bit-rate by not transmitting a start-phase for short tracks as the overhead of the start-phase data for a short track is proportionally higher than for a longer track.

There are a number of alternative criteria for determining whether a track is long enough to require a start phase or correspondingly short enough not to require a start-phase.

The simplest criterion is to pick an absolute track length—it has been found experimentally that tracks of less than 40 ms do not require a start phase whereas longer tracks are advantageously transmitted with a start-phase. In an encoder with an 8 ms update interval this means that tracks of less than 5 segments in length do not include a start-phase and rather include an indicator that a start-phase is not employed with the track. (It is assumed that it is more efficient to encode such an indicator, by comparison to a start-phase value.) Alternatively, if the encoder assumes that an encoded signal it produces will be decoded by a compatible decoder, the encoder then does not need to include an indication that no start-phase is employed and can leave it to the decoder to determine how to process tracks without a start-phase.

An alternative criterion is based on determining whether the time interval within which a track is located is voiced or non-voiced. Where time interval is determined to be voiced, it is assumed that this time interval non-tonal in nature and so tracks should not include a start-phase and vice versa for non-voiced time intervals. L. R. Rabiner, M. J. Cheng, A. E. Rosenberg, C. A. McGonegal, “A Comparative Performance Study of Several Pitch Detection Algorithms”, IEEE Transactions on Acoustics, Speech and Signal Processing, vol. ASSP-24, pp. 399-417, October 1976 discloses a method for making such a determination and by including a component implementing such a method within the tracking algorithm, the tracking algorithm will include start-phase information for tracks existing within a tonal time interval, whereas for tracks existing within a non-tonal time interval, no start-phase is included in the encoded bitstream. This criterion assumes that in a tonal time-interval, tracks will tend to be longer than in a non-tonal time-interval and so the final length of a track need not be known before a determination is made as to whether the track should include a start-phase or not.

An alternative method for determining whether a time interval represents a tonal or non-tonal audio signal is to look at the energy level of the noise component of the signal, discussed below. If it is found that the ratio of noise energy to sinusoidal component energy exceeds a given threshold for a given time interval, then in the same manner as above it can be assumed that the audio signal is non-tonal and that start-phase information need not be included in tracks and vice versa when the ratio of noise energy to sinusoidal component energy is below a given threshold. Again, it is assumed that where is signal is determined to be tonal, the tracks will tend to be longer than for a non-tonal signal.

In both the preferred embodiment and the prior art, the track is represented in subsequent segments by frequency differences, amplitude differences and, possibly for long tracks, phase differences (continuations) until the segment in which the track ends (death). In practice, it may be determined that there is little gain in coding phase differences even for long tracks. Thus, phase information need not be encoded for continuations at all and phase information for long tracks may be regenerated using continuous phase reconstruction.

As in the prior art, from the sinusoidal code CS generated with the improved sinusoidal coder of the invention, the sinusoidal signal component is reconstructed by a sinusoidal synthesizer (SS) 131. This signal is subtracted in subtractor 17 from the input x2 to the sinusoidal coder 13, resulting in a remaining signal x3 devoid of (large) transient signal components and (main) deterministic sinusoidal components.

The remaining signal x3 is assumed to mainly comprise noise and the noise analyzer 14 of the preferred embodiment produces a noise code CN representative of this noise, as described in, for example, WO 01/89086-A1 (Attorney Ref: PHNL000287). Again, it will be seen that the use of such an analyser is not essential to the implementation of the present invention, but is nonetheless complementary to such use.

Finally, in a multiplexer 15, an audio stream AS is constituted which includes the codes CT, CS and CN. The audio stream AS is furnished to e.g. a data bus, an antenna system, a storage medium etc.

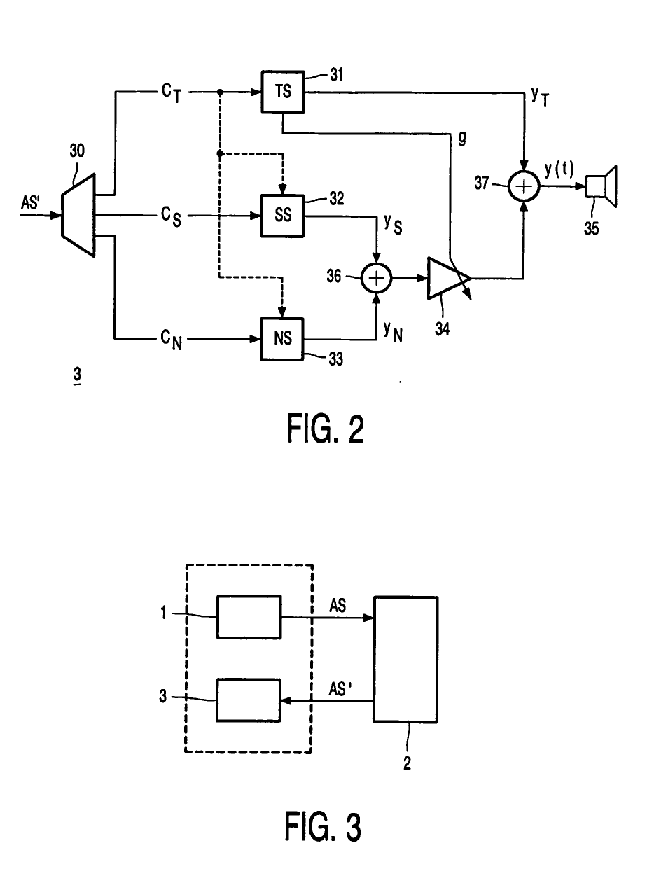

FIG. 2 shows an audio player 3 according to the invention. An audio stream AS′, e.g. generated by an encoder according to FIG. 1, is obtained from the data bus, antenna system, storage medium etc. The audio stream AS is de-multiplexed in a de-multiplexer 30 to obtain the codes CT, CS and CN. These codes are furnished to a transient synthesizer 31, a sinusoidal synthesizer 32 and a noise synthesizer 33 respectively. From the transient code CT, the transient signal components are calculated in the transient synthesizer 31. In case the transient code indicates a shape function, the shape is calculated based on the received parameters. Further, the shape content is calculated based on the frequencies and amplitudes of the sinusoidal components. If the transient code CT indicates a step, then no transient is calculated. The total transient signal yT is a sum of all transients.

The sinusoidal code CS is used to generate signal yS, described as a sum of sinusoids on a given segment. In the decoder, the phase of a sinusoid in a sinusoidal track is determined in one of two ways. Where the track includes a start-phase, as in the prior art, the phase is calculated from the phase of the originating sinusoid and the frequencies of the intermediate sinusoids. In the preferred embodiment, where the track includes an indication that no start-phase is provided, the decoder generates a random start phase for all sinusoids in the track and then synthesizes the track as before. (The decoder may alternatively calculate a random start-phase for the originating sinusoid only and calculate the remaining phases as in the prior art.) Where no such indication or start-phase is provided, the decoder assumes that it is required to produce a random start-phase for the sinusoids of the track.

It will be seen that one aspect of the invention is to preserve non-tonality in a non-tonal audio fragment. It may therefore be desireable when employing the present invention for the encoder to preserve very short tracks for non-tonal audio fragments and for the decoder to replay these short tracks with random start phases, unlike in the prior art where very short tracks are not included anywhere in a bitsteam.

At the same time, the noise code CN is fed to a noise synthesizer NS 33, which is mainly a filter, having a frequency response approximating the spectrum of the noise. The NS 33 generates reconstructed noise yN by filtering a white noise signal with the noise code CN.

The total signal y(t) comprises the sum of the transient signal yT and the product of any amplitude decompression (g) and the sum of the sinusoidal signal yS and the noise signal yN. The audio player comprises two adders 36 and 37 to sum respective signals. The total signal is furnished to an output unit 35, which is e.g. a speaker.

FIG. 3 shows an audio system according to the invention comprising an audio coder 1 as shown in FIG. 1 and an audio player 3 as shown in FIG. 2. Such a system offers playing and recording features. The audio stream AS is furnished from the audio coder to the audio player over a communication channel 2, which may be a wireless connection, a data 20 bus or a storage medium. In case the communication channel 2 is a storage medium, the storage medium may be fixed in the system or may also be a removable disc, memory stick etc. The communication channel 2 may be part of the audio system, but will however often be outside the audio system.

The present invention can be used in any sinusoidal audio coder. As such, the invention is applicable anywhere such coders are employed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding an audio signal (x), the method comprising the steps of:
providing a respective set of sampled signal values for each of a plurality of sequential segments;
analysing the sampled signal values to generate one or more sinusoidal components for each of the plurality of sequential segments;
linking sinusoidal components across a plurality of sequential segments;
generating sinusoidal codes comprising tracks of linked sinusoidal components for each of the plurality of sequential segments wherein each track comprises a frequency and amplitude for a sinusoidal component in a starting segment of a track, and wherein selected tracks do not include a phase for said starting segment; and
generating an encoded audio stream including said sinusoidal codes.

2. A method according to claim 1 wherein said selected tracks include an indicator that no phase is included for said starting segment.

3. A method according to claim 1 wherein said selected tracks are less than 5 segments in length.

4. A method according to claim 1 wherein said selected tracks are less than 40 ms in length.

5. A method according to claim 1 wherein said selected tracks represent non-tonal components of an audio signal.

6. A method according to claim 1 wherein said selected tracks represent a component of a voiced time interval in said audio signal.

7. A method according to claim 1 wherein said selected tracks represent a component of a noisy interval in said audio signal.

8. A method according to claim 1 in which each track comprises a frequency and amplitude difference for each sinusoidal component in a subsequent continuation segment of said track.

9. Method of decoding an audio stream, the method comprising the steps of:
reading an encoded audio stream including sinusoidal codes comprising tracks of linked sinusoidal components for each of the plurality of sequential segments, wherein each track comprises a frequency and amplitude for a sinusoidal component in a starting segment of a track, and wherein selected tracks do not include a phase for said starting segment;
generating for said selected tracks a random start phase; and
employing said sinusoidal codes to synthesize said audio signal including re-constructing sinusoidal components across a plurality of sequential segments.

10. A method as claimed in claim 9 wherein said generating step comprises generating a random phase for each sinusoidal component of said selected tracks.

11. Audio coder arranged to process a respective set of sampled signal values for each of a plurality of sequential segments of an audio signal (x), said coder comprising:
an analyser arranged to analyse the sampled signal values to generate one or more sinusoidal components for each of the plurality of sequential segments;
a linker arranged to link sinusoidal components across a plurality of sequential segments;
a component arranged to generate sinusoidal codes comprising tracks of linked sinusoidal components for each of the plurality of sequential segments wherein each track comprises a frequency and amplitude for a sinusoidal component in a starting segment of a track, and wherein selected tracks do not include a phase for said starting segment; and
a bit stream generator for generating an encoded audio stream including said sinusoidal codes.

12. Audio player, comprising:
means for reading an encoded audio stream including sinusoidal codes comprising tracks of linked sinusoidal components for each of the plurality of sequential segments, wherein each track comprises a frequency and amplitude for a sinusoidal component in a starting segment of a track, and wherein selected tracks do not include a phase for said starting segment;
a phase generator arranged to generate for said selected tracks a random start phase; and
a synthesizer employing said sinusoidal codes to synthesize said audio signal including re-constructing sinusoidal components across a plurality of sequential segments.

13. Audio system comprising an audio coder as claimed in claim 11.

14. Audio stream comprising sinusoidal codes representative of at least a component of an audio signal, said codes comprising tracks of sinusoidal components linked across said plurality of sequential segments, wherein each track comprises a frequency and amplitude for a sinusoidal component in a starting segment of a track, and wherein selected tracks do not include a phase for said starting segment.

15. Storage medium on which an audio stream as claimed in claim 14 has been stored.
